(19) United States
(12) Patent Application Publication
(10) Pub. No.: US 2009/0125441 A1
(43) Pub. Date: May 14, 2009

(54) Monetary Account Management

(76) Inventors: Cameron Allen Minges, Carmel, IN (US); Douglas A. True, New Palestine, IN (US); Charles Andrew Mattingly, Fishers, IN (US)

Correspondence Address: BARNES & THORNBURG LLP, 11 SOUTH MERIDIAN, INDIANAPOLIS, IN, 46204, US

(21) Appl. No.: 11/938,880

(22) Filed: Nov. 13, 2007

(51) Int. Cl. G06Q 40/00; G06Q 90/00

(52) U.S. Cl. 705/39

(57) ABSTRACT

Methods, systems, and machine readable media are disclosed that may use a float account to manage monetary accounts associated with an account holder. In one embodiment, a method may include receiving a transaction for the float account that has an associated monetary amount. The method may also include holding the monetary transaction in the float account of the account holder. The method may include distributing the monetary amount of the transaction among the monetary accounts of the account holder per directions of the account holder.

### BACKGROUND

Consumers commonly maintain multiple accounts with a bank, credit union, brokerage firm, and/or other financial institution. For example, a consumer may have a checking account, savings account, home equity line of credit, personal line of credit, credit card account, home mortgage, car loan, as well as other monetary accounts with a financial institution. Furthermore, many financial institutions provide an online interface that enables their account holders to view account activity, pay bills, and transfer funds among accounts. These online interfaces are generally accessible from just about any computing device having a web browser and Internet connectivity, and as a result provide account holders with a very convenient tool for managing their accounts.

### SUMMARY OF THE DISCLOSURE

The present invention may comprise a system, apparatus and/or method that may have one or more of the following features and/or steps, which alone or in any combination may comprise patentable subject matter.

A method of using a float account to manage monetary accounts associated with an account holder is provided. The method may include receiving a transaction for the float account such as a deposit or a withdraw that has an associated monetary amount. The method may also include holding the monetary transaction in the float account of the account holder. Further, the method may include distributing the monetary amount of the transaction among the monetary accounts of the account holder.

In particular, the method may distribute the monetary amount of the transaction in response to receiving directions from the account holder prior to expiration of a float time period assigned to the transaction. The directions may indicate how the monetary amount is to be distributed among the monetary accounts associated with the float account. For example, the monetary amount may be distributed to a single identified monetary account in response to receiving directions to allocate the monetary amount of the transaction to the single identified monetary account. Similarly, the monetary amount may be distributed among two or more monetary accounts in response to receiving directions to distribute the monetary amount of the transaction among the two or more monetary accounts.

In an embodiment, the method may allocate the monetary amount of the transaction to a default account of the monetary accounts in response to the float time period for the transaction expiring prior to receiving directions from the account holder. The method may also include an option to extend the float time period associated with transaction in response to the float time period for the transaction expiring, and charge the account holder for extending the float time period. The method may further include extending the float time period associated with the transaction in response a request from the account holder to extend the float time period, and charging the account holder for extending the float time period.

The method in some embodiments may include adding the transaction to an inbox that includes transactions to be distributed among the monetary accounts of the account holder. The method may further include presenting transactions of the inbox to the account holder in response to the account holder accessing the inbox. The method may also assign an identified category to the transaction in response to receiving directions to assign the identified category to the transaction. Similarly, the method may include assigning two or more categories to the transaction per an identified apportionment of the monetary amount of the transaction in response to receiving directions to assign the two or more categories to the transaction per the identified apportionment of the monetary amount of the transaction. The method may also receive a transaction in response to a deposit to the float account, and may distribute the monetary amount among one or more allocation folders backed by one or more deposit accounts of the monetary accounts per directions received from the account holder.

The method may also receive the transaction in response to various types of transactions. For example, the method may receive the transaction in response to a credit transaction using a transaction card associated with the float account. The method may also receive the transaction in response to a debit transaction using a transaction card associated with the float account. The method may also receive the transaction in response to an automated clearing house (ACH) deposit to the float account or an automated clearing house (ACH) debit from the float account. Furthermore, the method may receive the transaction in response to an automated payroll deposit to the float account. The method may further receive the transaction in response to credit transaction drawn from the float account, or a debit card transaction drawn from the float account. The method may also receive the transaction in response to bill pay transactions associated with a utility company or other service provider or in response to automated teller machine (ATM) transactions. In some embodiments, the method may reward the account holder for transactions that originated from entities that have subscribed to a rewards program. Moreover, such rewards may replace or enhance current reward programs of a merchant.

A machine readable medium comprising instructions is also described herein. The instructions in response to being executed may result in an account management system identifying a cardholder of a received card transaction that has an associated monetary amount. The instruction may further result in the account management system distributing the monetary amount of the card transaction among a plurality of monetary accounts of the cardholder in response to receiving, prior to expiration of a float time period assigned to the card transaction, directions from the cardholder to distribute the monetary amount of the card transaction among the plurality of monetary accounts. In particular, the instructions may result in the system distributing the monetary amount to a single identified monetary account of the cardholder per directions of the cardholder. Similarly, the instructions may result in the system distributing the monetary amount of the card transaction among two or more monetary accounts of the cardholder per directions of the cardholder. The two or more monetary accounts may be of the same financial institution or different financial institutions.

In one embodiment, the instructions of the machine readable medium may result in the system allocating the monetary amount of the card transaction to a default account of the cardholder in response to the float time period for the card transaction expiring prior to receiving directions from the cardholder. In another embodiment, the instructions may result in the system extending the float time period associated with card transaction, and charging the cardholder for extending the float time period. The instructions may also result in the system adding the card transaction to an inbox comprising card transactions to distribute among monetary accounts of cardholder, and presenting transactions of the inbox to the cardholder in response to the cardholder accessing the inbox.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows a transaction processing system having an account management system to manage monetary accounts.

FIGS. 2-5 show aspects of a web interface of the account management system of FIG. 1.

FIG. 6 shows a method that may be used by the account management system of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

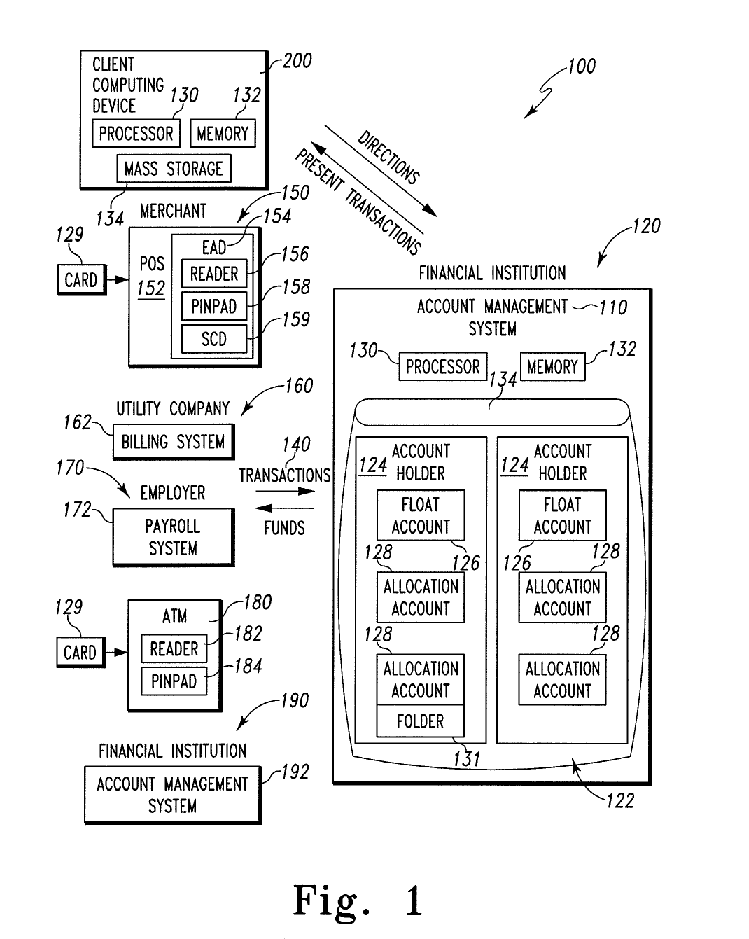

Referring now to FIG. 1, a high level diagram of a transaction processing system 100 is shown. As shown, the transaction processing system 100 may include an account management system 110 of a financial institution 120 such as, for example, a bank, credit union, or brokerage firm. As shown, the financial institution 120 may include one or more accounts 122 for each of the account holders 124 of the financial institution 120. In particular, the financial institution 120 may manage a float account 126 of an account holder 124 and one or more allocation accounts 128 of the account holder 124. The allocation accounts 128 may include savings accounts, credit accounts, checking accounts, personal lines of credit accounts, home equity lines of credit accounts, and/or other types of investment accounts that have been associated with an account holder's float account 126. Moreover, the allocation accounts 128 may include user defined allocation folders 131 to which an account holder 124 may assign transactions 140. For example, an account holder 124 may create an allocation folder 131 labeled “motorcycle” in a savings account of the allocation accounts 128. Instead of assigning a monetary amount of transaction to the savings account, the account holder 124 may assign the monetary amount to the “motorcycle” allocation folder 131. The monetary amount may still post to the savings account; however, the folder 131 may provide the account holder 124 a convenient way of allocating funds for a special purchase without needing to set up a separate saving account.

The financial institution 120 may also issue an account holder 124 a card 129 that is tied to a float account 126 of the account holder 124. The card 129 may be similar in form and/or function to a credit card, debit card, charge card, and/or ATM card. The card 129 may be used for purchases, cash and deposits. When the card 129 is used for purchases, the card 129 may operate similar to a debit card where the card 129 may be swiped through a card reader, and the cardholder may either type in a personal identification number (PIN) or sign their name to authorize the monetary amount of the purchase. The purchase or transaction 140 may be approved like a normal debit card purchase, and as far as a merchant 150 is concerned, the transaction 140 is like any other debit card purchase. However, in one embodiment, the account management system 110 of the financial institution 120 per directions from the account holder 124 may hold the purchase amount in a float account 126 of the account holder 124 for a float period (e.g. 10 days or some other specified period of time) instead of immediately funding the purchase amount from an allocation account 128 of the account holder 124.

The account management system 110 of the financial institution 120 may receive and process transactions 140 directed to the float accounts 126 of the account holders 124. As shown, the monetary transactions 140 may originate from various third parties such as, for example, merchant 150, utility company 160, employer 170, ATM 180 and other financial institutions 190. Furthermore, the account management system 110 may receive directions, from account holders 124 via client computing devices 200. The directions may instruct the account management system 110 how to distribute the transactions 140 among the allocation accounts 128 associated with the float account 126.

The account management system 110 may include one or more computing devices that may each include processors 130, memory devices 132, and mass storage devices 134. The memory devices 132 and mass storage devices 134 may store data and/or instructions that in response to being executed by the processors 130 result in the account management system 110 performing actions indicated by the instructions. To this end, the memory devices 132 may include volatile memory devices such as, for example, dynamic random access memory devices (DRAM) and non-volatile memory devices such as, for example, flash memory devices. The mass storage devices 134 may include hard disk drives, tape drives, CD-ROM drives, DVD-ROM drives, and/or other devices capable of storing instructions and/or data. Furthermore, the processors 130 may include integrated circuits, ASIC (application specific integrated circuit) devices, microcontrollers, and/or discrete components to execute instructions stored by the memory devices 132 and/or mass storage devices 134. In particular, the processors 120 may include one or more microprocessors provided by International Business Machines, Sun Microsystems, Intel Corporation and/or Advanced Micro Devices.

As stated above, the monetary transactions 140 may originate from third parties such as, merchant 150, utility company 160, employer 170, ATM 180 and/or other financial institutions 190. In particular, monetary transactions 140 may originate from a merchant 150 as a result of an account holder 124 purchasing goods and/or services from the merchant 150. To this end, a point of sale terminal 152 of the merchant 150 may process the sale of goods and/or services to the account holder 124. The point of sale terminal 152 may include an electronic authorization device 154 that authorizes purchases made via a card 129 that draws from a float account 126 of the account holder 124. The electronic authorization device 154 may include a card reader 156, a pinpad 158, and a signature capture device 159. As a card 129 is swiped, the carder reader 156 may read information such as, for example, an account number of the float account 126 from a magnetic strip of the credit card, charge card, or debit card. The pinpad 158 may include keys which enable a cardholder to enter a PIN (personal identification number) that may be used to authenticate the transaction 140 and the associated monetary amount of the transaction 140. Similarly, the signature capture device 159 may include a touch screen, digitizer, scanner and/or other input device which enables the cardholder to sign for the transaction 140 and thus authenticate the transaction 140 and the associated monetary amount via the cardholder's signature.

Monetary transactions 140 may also originate from a utility company 160 such as, for example, telephone company, cable television company, electric company, or water company to name a few. The utility company 160 may include a billing system 162 that generates a monetary transaction 140 for payment of monthly service fees associated with an account holder 124 of the financial institution 120. The billing system 162 may include one or more computing devices that cooperate to provide billing services of the utility company 160. Thus, the billing system 162 may include processors, memory devices, and mass storage devices similar to those of the account management system 110 of the financial institution 120. The billing system 162 may direct a debit card transaction, credit card transaction, charge card transaction, an automated clearing house (ACH), and/or some other monetary transaction 140 to a float account 126 of an account holder 124.

An employer 170 of an account holder 124 may also originate monetary transactions 140. The employer 170 may include a payroll system 172 that manages the payroll of the employer 170. The payroll system 172 may include one or more computing devices that cooperate to provide payroll services of the employer 170. Thus, the payroll system 172 may include processors, memory devices, and mass storage devices similar to those of the account management system 110 of the financial institution 120. The payroll system 172 may direct an automated clearing house (ACH), and/or some other monetary transaction 140 to a float account 126 of an employee account holder 124 in order to deposit the employee's pay.

An automated teller machine (ATM) 180 may also originate monetary transactions 140 directed to a float account 126 of the financial institution 120. The ATM 180 may include a card reader 182 and a pinpad 184. As a card 129 is swiped, the carder reader 182 may read information such as, for example, an account number of the float account 126 from a magnetic strip of the card 129. The pinpad 184 may include keys which enable a cardholder to enter a PIN (personal identification number) that may be used to authenticate the transaction 140 and the associated monetary amount of the transaction 140.

Further, monetary transactions 150 may originate from other financial institutions 190 such as, for example, banks, credit unions, brokerage firms, and/or home loan companies. The other financial institutions 190 may include account management systems 192 similar to the account management system 110 to manage accounts of account holders. The account management systems 192 of the other financial institutions 190 may include one or more computing devices that cooperate to provide account services to the account holders. Thus, the account management system 192 of the other financial institutions 190 may include processors, memory devices, and mass storage devices similar to those of the account management system 110 of the financial institution 120. The account management systems 192 may direct a debit card transaction, credit card transaction, charge card transaction, an automated clearing house (ACH), and/or some other monetary transaction 140 to a float account 126 of the financial institution 120. In this manner, the account management systems 192 may transfer funds between accounts of the financial institutions 120, 190.

A client computing device 200 is also shown in FIG. 1. The client computing device 200 may include processors 130, memory devices 132 and mass storage devices 134 similar to those of the account management system 110. The client computing device 200 may be implemented via a laptop computer, desktop computer, handheld computer, cell phone, and/or other computing device having communications capabilities. Furthermore, the client computing device 200 may include a web browser capable of accessing a web interface of the account management system 110 via a public network such as the Internet.

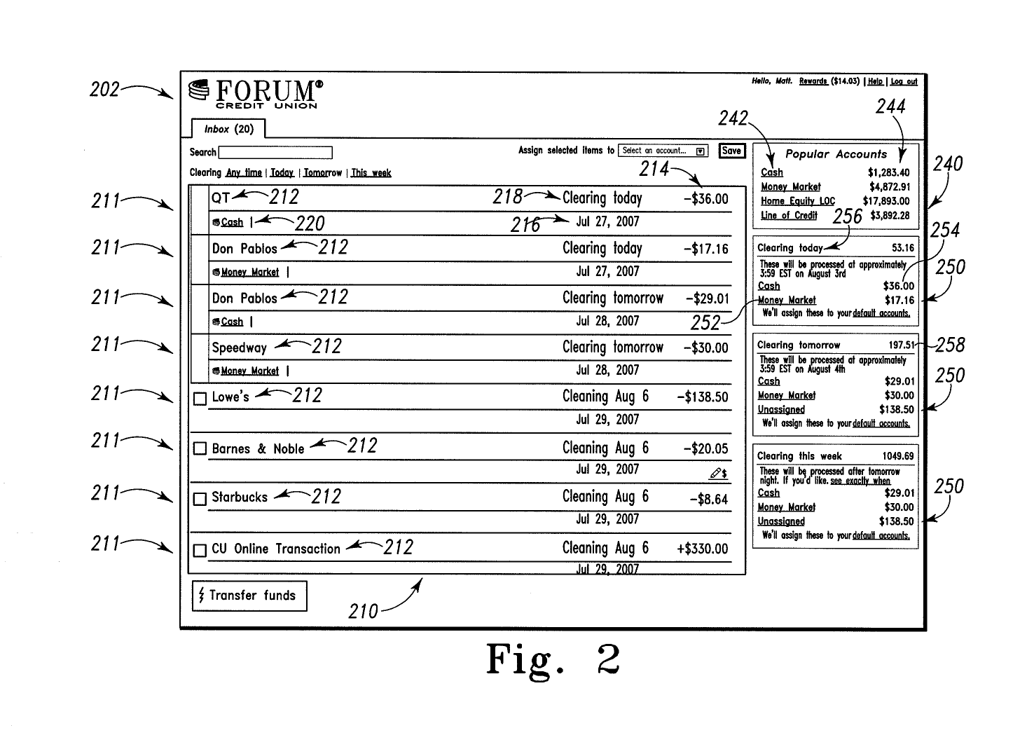

The account management system 110 may present the client computing device 200 of an account holder 124 with information regarding transactions 140 received for accounts 122 of the account holder 124. In one embodiment, the account management system 110 may present such information to the account holder 124 via a web interface 202, aspects of which are shown in FIGS. 2-5. Referring now to FIG. 2, an inbox 210 of the web interface 202 may include a transaction item 211 for each transaction 140 being held by the float account 126 of an account holder 124. In one embodiment, each transaction item 211 includes a transaction identifier 212, monetary amount 214, transaction date 216, clearing date 218, and assigned allocation account 220.

The web interface 202 may further include one or more allocation account views 240 that provide information for each or a subset (e.g. the most used or popular) of each allocation account 128 of the account holder 124. The allocation account view 240 may show account identifiers 242 and balances 244 for each allocation account 128. For example, FIG. 2 shows account identifiers 242 and balances 244 for cash, money market, home equity line of credit, personal line of credit, or other allocation accounts 128.

The web interface 202 may further include one or more clearing views 250 that provide information regarding transactions to be cleared against allocation accounts 128. As shown, a clearing view 250 may include an account identifier 252 that identifies an allocation account 128 and a monetary amount 254 to be applied to the identified allocation account 128. The clearing view 250 may further include a clearing date 256 that identifies when the monetary amounts 254 will be credited to or drawn from the identified allocation accounts 128. The clearing view 250 may also indicate the total monetary amount 258 to be cleared for the period specified by the clearing date 256.

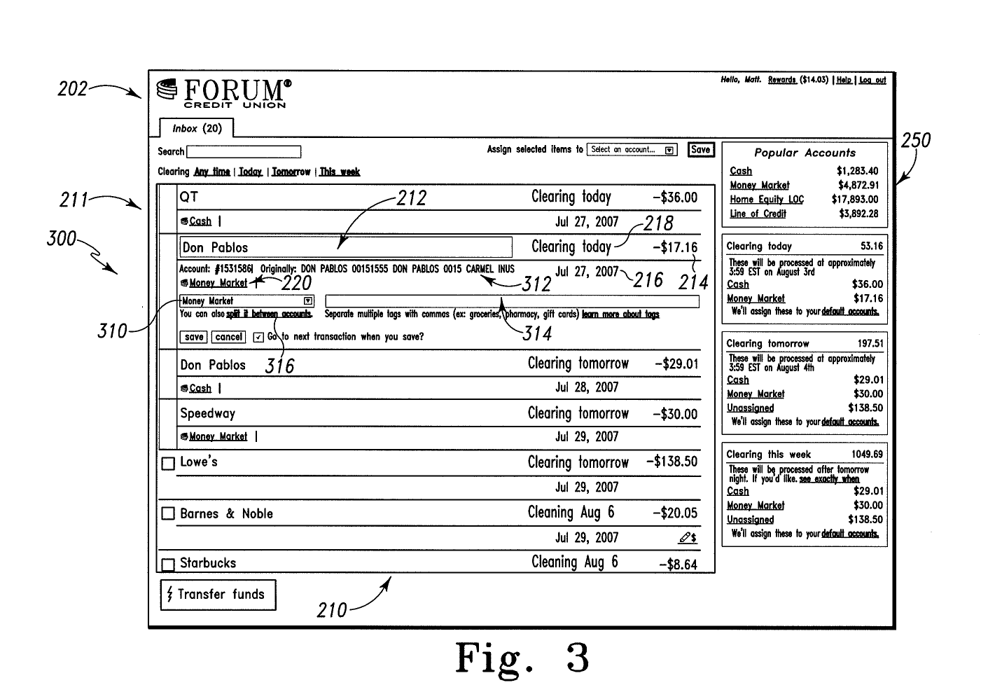

Referring now to FIG. 3, an expanded transaction item 300 is shown. As shown, the expanded transaction item 300 may include information of a transaction item 211 such as transaction identifier 212, monetary amount 214, transaction date 216, clearing date 218, and assigned allocation account 220. Furthermore, the expanded transaction item 300 may include additional information such as account allocation control 310, detailed transaction identifier 312, categorization or tagging control 314, and split transaction control 316. In one embodiment, an account holder 124 may edit the transaction identifier 212 and as such may be referred to as a user supplied transaction identifier. The detailed transaction identifier 312 may comprise information supplied by the originator of the corresponding transaction 140 such as street address, store number and/or other information identifying the vendor that originated the transaction 140.

The expanded transaction item 300 of FIG. 3 depicts a user specified transaction identifier 212 of “Don Pablos” and vendor supplied or detailed transaction identifier 312 of “DON PABLOS 00151555 DON PABLOS 0015 CARMEL INUS.” In one embodiment, the account management system 110 may allow the account holder 124 to specify a transaction identifier 212 for a particular transaction 140 from a vendor. Moreover, for future transactions, the account management system 110 may automatically associate the user specified transaction identifier 212 with transactions 140 from the same vendor. For example, the account management system 110 may automatically assign the user specified transaction identifier “Don Pablos” with any future transactions received from “DON PABLOS 00151555 DON PABLOS 0015 CARMEL INUS.”

The account allocation control 310 may provide the account holder 124 with a list of allocation accounts 128 to which the monetary amount 214 may be assigned. Thus, via the account allocation control 310 an account holder 124 may specify a single allocation account 128 to fund the transaction 140 or to receive the funds of the transaction 140 as the case may be. The split transaction control 316 may provide the account holder 140 with an interface for specifying an apportionment of the monetary amount 214 to be distributed or split among the allocation accounts 128. For example, the split transaction control 316 may present the account holder 124 with a list of allocation accounts 128 and associated input boxes into which the account holder 124 may enter a monetary amount to assign to each allocation account 128.

The categorization or tagging control 314 may provide a mechanism via which an account holder 124 may assign the transaction 140 to one or more categories such as, for example, groceries, pharmacy, gift cards, etc. The account holder 124 may assign categories or tag transactions 140 in order to easily locate and track transactions associated with certain income and expense categories.

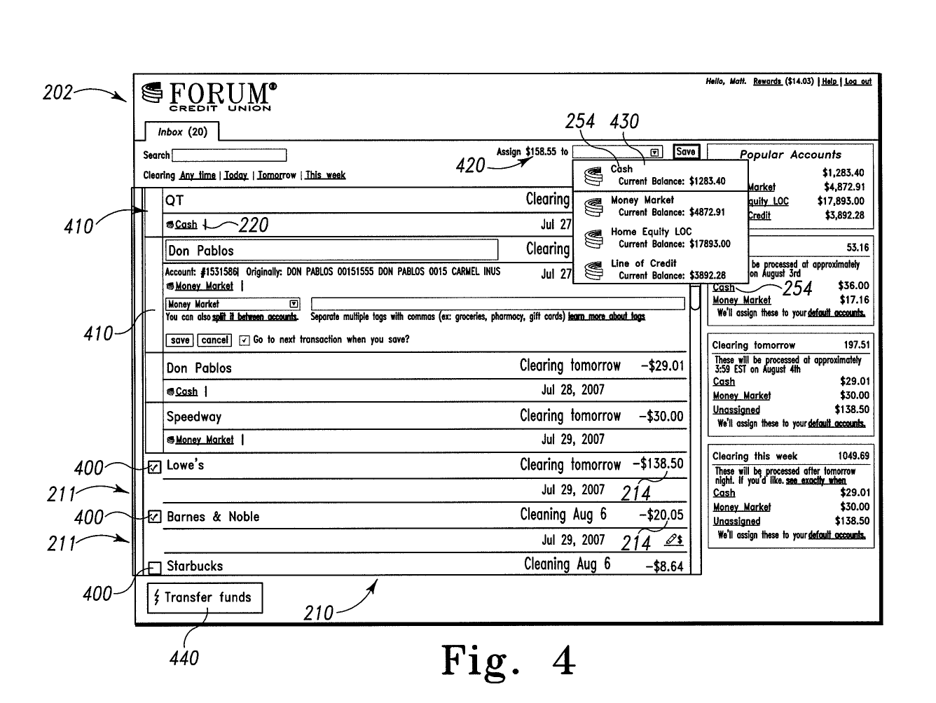

The web interface 202 may further support assigning multiple transaction items 211 to a single allocation account 128 as shown in FIG. 4. In particular, the web interface 202 may include check box controls 400 or some other type of control via which an account holder 128 may select transaction items 211 of the inbox 210. The web interface 202 may further display a total assigned amount 420 that identifies the sum of the monetary amounts 214 of the selected transaction items 211. The web interface may also include an allocation account control 430 and a transfer control 440. The allocation account control 430 may present the account holder 124 with a listing of allocation account identifiers 254 for allocation accounts 128 of the account holder 124 and may enable the account holder 124 to select one of the listed allocation identifiers 254. The transfer control 440 in one embodiment comprises a button control that in response to being activated (e.g. clicked) results in the account management system 110 assigning the monetary amounts 214 of the selected transaction items 211 to the allocation account 128 selected via the allocation account control 430.

The web interface 202 may further include status indicators 410 to indicate which transaction items 211 have already been assigned to an allocation account 128. In on embodiment, the status indicators 410 may include a colored bar on the left hand side of the transaction item 211. Moreover, the web interface 202 may display the colored bar of the status indicator 410 as well as corresponding account identifiers 220, 254 in matching colors to aid the account holder 124 in identifying which transaction items 211 have been assigned to allocation accounts 128. For example, the web interface 202 may use the color green for status indicators 410 and account identifiers 220, 254 associated with a cash account.

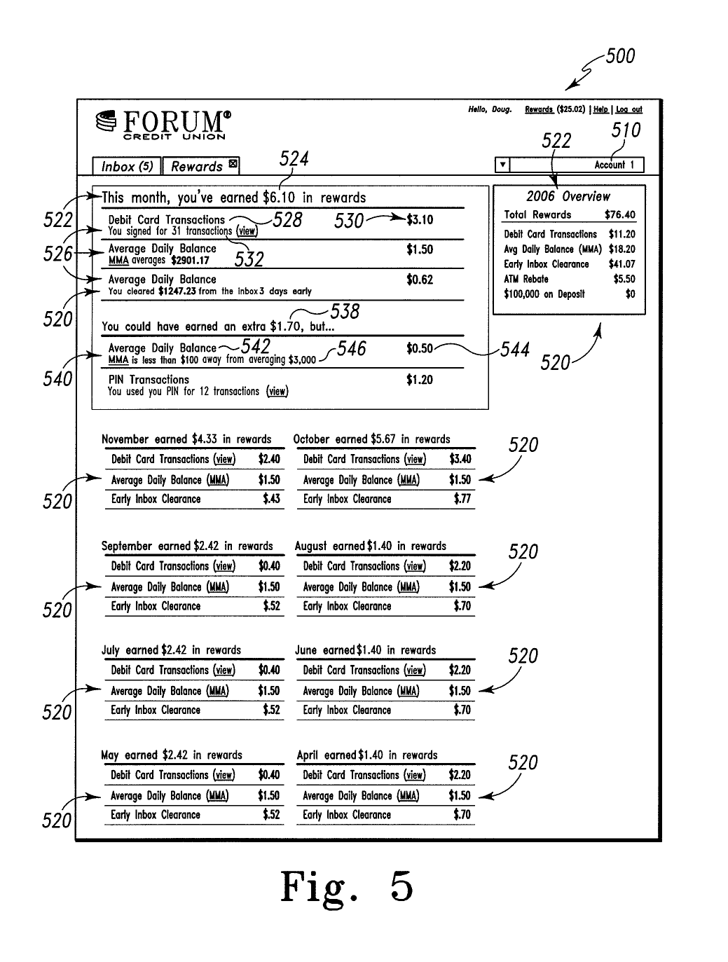

Rewards of an account holder 124 are summarized by the rewards interface 500 shown in FIG. 5. As shown, the rewards interface 500 may include an account selection control 510 which enables an account holder 124 to select an account 128 in order to see rewards earned regarding the selected account. The rewards interface 500 may further include one or more earned reward controls 520 which may present the account holder 124 with information regarding rewards earned for an identified time period. The earned reward control 520 may include a time period identifier 522 (e.g. This Month, Last Month, November, October, etc.) that identifies the time period being presented by the reward control 520. The reward control 520 may further include a reward total 524 that indicates the total amount of rewards earned for the period specified by the time period identifier 522.

The earned reward control 520 may also include earned reward items 526 that each have a reward identifier 528, an associated reward amount 530, and a reward explanation 532. The reward identifier 528 may provide a brief description of the reward type or source of the earned reward 530. The reward explanation 532 may provide more details regarding the reward type and/or source of the earned reward. For example, as shown in FIG. 5, the reward control 520 may include an earned reward item 526 having a reward identifier 528 of “Debit Card Transactions” and a reward explanation 532 of “You signed for 31 transactions” thus indicating that the earned reward amount 530 of $3.10 is due to signing for thirty-one (31) debit card transactions.

As shown, a financial institution 120 may reward its account holders 124 for signing for debit card transaction instead of entering a PIN to authorize the transaction since a lower fee is charged to the financial institution 120 for signed debit card transactions than for debit card transactions authorized via a PIN. The financial institution 120 may further reward its account holders 124 for maintaining certain balances such as average daily balances or total deposit levels. Moreover, the financial institution 120 may also reward its account holders 124 for clearing transactions from their inbox 210 before the expiration of the float period.

In one embodiment, the financial institution 120 may provide the account holder 124 with a float period during which a transaction 140 remains in the inbox 210. If the float period for a transaction 140 expires before the account holder 124 assigns the transaction 140 to an allocation account 128, the account management system 110 may assign the transaction 140 to a default account that the account holder 124 has designated. For example, the account holder 124 may designate their checking account labeled as “cash” in FIGS. 2-5 as the default account. The account management system 110 in turn may transfer a transaction 140 in the inbox 210 to the designated default account in response to the float period for the transaction 140 expiring.

Since the financial institution 120 in one embodiment does not charge interest for transactions held in the float account 126 during the float period, the account holder 124 basically enjoys a short term interest free loan during the float period for transaction 140. Thus, to encourage early clearing of such transactions 140 from the inbox 210 and the backing float account 126, a financial institution 120 may reward the account holder 124 for clearing transaction 140 prior to the float period expiring for a transaction.

Other types of rewards tied to usage of the card 129 are also envisioned. For example, since the account management system 120 has the capability to track where purchases are made, relationships with retailers may be established to offer coupons/discounts to account holders 124 who spend money at their stores. The financial institution 120 may further contract with a retailer such that the card 129 functions as a discount card at those stores. For example, the financial institution 120 may establish an agreement with a merchant 150 which entitles the account holder 124 to a 10% discount on purchases made with their card 129. With the ability to track transactions and categorize them based on merchant type, rewards may also be given based on that merchant category. For example, an account holder 124 may be rewarded for setting up their utilities to be paid through their card 129.

The reward control 520 may further include increased reward items 540 which may present the account holder 124 with information on how the account holder 124 may have increased the earned reward for the identified time period. The reward control 520 may further include a increased reward total 538 that indicates the total amount of rewards earned for the period specified by the time period identifier 522. Each increased reward item 540 may include a reward identifier 542, an associated increased reward amount 544, and an increased reward explanation 546. The increased reward identifier 542 may provide a brief description of the reward type and/or source of the reward that may have been increased if the account holder 124 had acted differently. The increased reward explanation 544 may provide more details regarding the reward type and/or source of the reward that may be increased in the future. For example, as shown in FIG. 5, the reward control 520 may include an increased reward item 540 having a reward identifier 542 of “PIN Transactions” and a reward explanation 546 of “You used your PIN for 12 transactions” thus indicating that the account holder 124 could have earned an additional reward amount 544 of $1.20 if the account holder 124 had signed for such transactions instead of using their PIN.

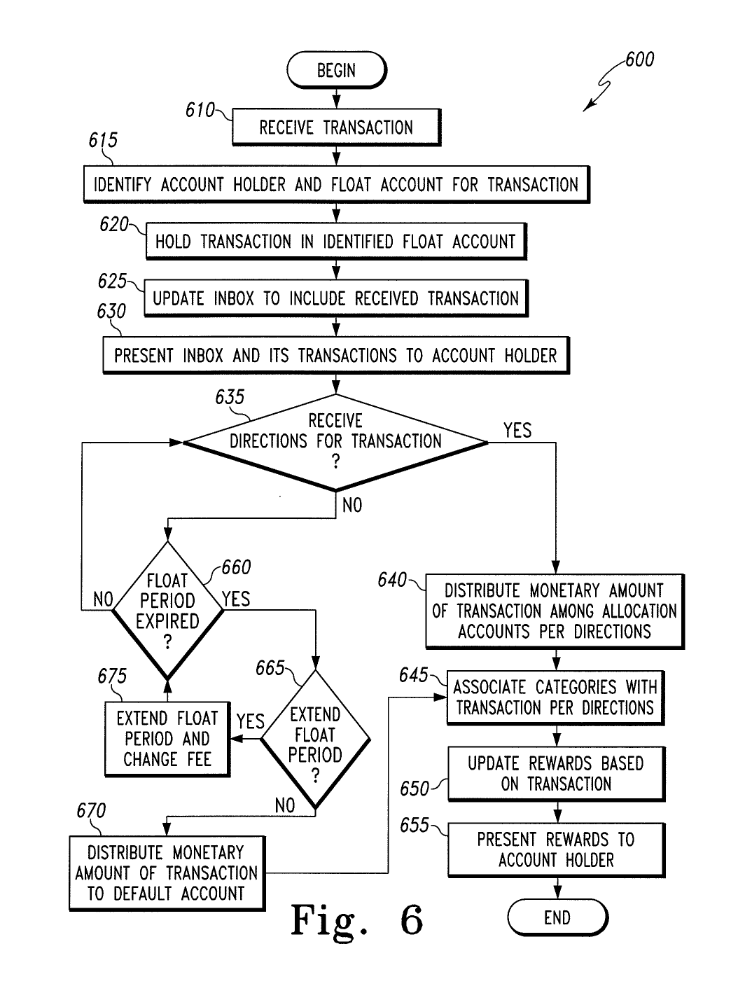

A method 600 that may be used by the account management system 110 to process transactions 140 is shown in FIG. 6. The method 600 may begin at block 610 with the account management system 110 receiving a transaction 140. As discussed above, the transaction 140 may originate from numerous locations such as a merchant 150, utility company 160, employer 170, ATM 180, and/or other financial institution 190. At block 615, the account management system 110 may identify the account holder 124 and float account 126 associated with the transaction 140. To this end, the account management system 110 may determine the account holder 124 and float account 126 based upon information provided by the transaction 140 and information stored in memory devices 132 and/or mass storage devices 134.

At block 620, the account management system 110 may hold the transaction 140 in the identified float account 126. The account management system 110 may further update at block 625 an inbox 210 associated with the account holder 124 and float account 126 to include a transaction item 211 and may populate the transaction item 21 with pertinent data garnered from the transaction 140, memory devices 132 and/or mass storage device 134.

The account management system 110 may present the inbox 210 and its transaction items 211 to the account holder 124 at block 630. In one embodiment, the account management system 110 may present an account holder 124 their the inbox 210 via the web interface 202 in response to the account holder 124 logging into the account management system 110 via the web browser of client computing device 200. At block 635, the account management system 110 may determine whether directions for the transaction 140 have been received from the account holder 124. As discussed above in regard to FIGS. 2-4, the account holder 124 may provide the account management system 110 with directions via the web interface 202.

If the account management system 110 has received directions for the transaction 140, the account management system 110 at block 640 may distribute the monetary amount 214 of the transaction 140 among allocation accounts 128 per directions of the account holder 124. The account management system 110 may further associate one or more categories (e.g. groceries, utilities, entertainment) to the transaction 140 per directions of the account holder 124 at block 645. Moreover, the account management system 110 at block 650 may update rewards earned by the account holder 124 based upon the transaction 140 and may present the updated rewards to the account holder 124 at block 655 via the web interface 202.

If the account management system 110 has not received directions for the transaction 140, the account management system 110 at block 660 may determine whether a float period for the transaction 140 has expired. In an embodiment having a 10 day float period, the account management system 110 may determine that float period has expired after 10 days from the transaction date 216 have passed.

If the float period has not expired, then the account management system 110 may return to block 635 to determine whether directions for the transaction 140 have been received. Otherwise, the account management system 110 at block 665 may determine whether to extend the float period 665. The account management system 110 may use a variety of criteria in order to determine whether to extend the float period. For example, if the account holder 124 has designated an allocation account 128 as a default account, then the account management system 110 may decide against extending the float period and may instead simply post the transaction 140 to the default account after expiration of the float period, thus possibly overdrawing the default account. In another embodiment, the account management system 110 may decide to extend the float period if the posting to the default account would overdraw the default account. In one embodiment, the account management system 110 may extend the float period in response to directions from the account holder 124 to extend the float period. Such directions may be on a per transaction basis and/or may be a default direction to be applied to all transaction once the float period expires. For example, the account holder 124 instead of setting up a default account may simply instruct the account management system 110 to automatically extend the float period for any transaction 140 whose float period has expired. The financial institution 120 and/or the account holder 124 may configure the account management system 110 in other embodiments to extend the float period based upon criteria other than those mentioned above.

In response to determining to extend the float period of the transaction 140, the account management system 110 at block 675 may extend the float period of the transaction 140 and may charge the account holder 124 a fee for the extension. The account management system 110 may then return to block 660 to determine whether the extended float period has expired.

In response to determining not to extend the float period of the transaction 140, the account management system 110 at block 670 may distribute the monetary amount of the transaction 140 to a default account of the allocation accounts 128. In one embodiment, the account holder 124 may set-up categories to be automatically applied to transactions 140 from certain sources. As such, the account management system 110 may continue to block 645 in order to categorize the transaction 140, update rewards, and present such rewards to the account holder 124.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

What is claimed is:

1. A method of using a float account to manage a plurality of monetary accounts associated with an account holder, comprising
receiving a transaction for the float account, the transaction having an associated monetary amount,
holding the monetary transaction in the float account of the account holder, and
distributing the monetary amount of the transaction among the plurality of monetary accounts in response to receiving, prior to expiration of a float time period assigned to the transaction, directions from the account holder to distribute the monetary amount of the transaction among the plurality of monetary accounts associated with the float account.

2. The method of claim 1, wherein distributing the monetary amount comprises distributing the monetary amount to a single identified monetary account of the plurality of monetary accounts in response to receiving directions to allocate the monetary amount of the transaction to the single identified monetary account.

3. The method of claim 1, wherein distributing the monetary amount comprises distributing the monetary amount of the transaction among two or more monetary accounts of the plurality of monetary accounts in response to receiving directions to distribute the monetary amount of the transaction among the two or more monetary accounts.

4. The method of claim 1, further comprising
adding the transaction to an inbox comprising transactions to distribute among the plurality of monetary accounts, and
presenting transactions of the inbox to the account holder in response to the account holder accessing the inbox.

5. The method of claim 1, further comprising assigning an identified category to the transaction in response to receiving directions to assign the identified category to the transaction.

6. The method of claim 1, further comprising assigning two or more categories to the transaction per an identified apportionment of the monetary amount of the transaction in response to receiving directions to assign the two or more categories to the transaction per the identified apportionment of the monetary amount of the transaction.

7. The method of claim 1, further comprising allocating the monetary amount of the transaction to a default account of the plurality of monetary accounts in response to the float time period for the transaction expiring prior to receiving directions from the account holder.

8. The method of claim 1, further comprising
extending the float time period associated with the transaction in response to the float time period for the transaction expiring, and
charging the account holder for extending the float time period.

9. The method of claim 1, further comprising
extending the float time period associated with transaction in response a request from the account holder to extend the float time period, and
charging the account holder for extending the float time period.

10. The method of claim 1, wherein receiving the transaction comprises receiving the transaction in response to a credit transaction using a transaction card associated with the float account.

11. The method of claim 1, wherein receiving the transaction comprises receiving the transaction in response to a bill payment transaction associated with a utility company.

12. The method of claim 1, wherein receiving the transaction comprises receiving the transaction in response to a debit transaction using a transaction card associated with the float account.

13. The method of claim 1, wherein receiving the transaction comprises receiving the transaction in response to an automated clearing house (ACH) transaction.

14. The method of claim 1, wherein receiving the transaction comprises receiving the transaction in response to an automated payroll deposit to the float account.

15. The method of claim 1, wherein receiving the transaction comprises receiving the transaction in response to card transaction drawn from the float account.

16. The method of claim 1, further comprising rewarding the account holder for transactions that originated from entities that have subscribed to a rewards program.

17. The method of claim 1, further comprising rewarding the account holder authenticating a card transaction via signature instead of via a personal identification number.

18. The method of claim 1, further comprising presenting the account holder with a reward amount earned and ways to earn increase future reward amounts.

19. The method of claim 1, wherein receiving the transaction comprises receiving the transaction in response to a deposit to the float account, and distributing the monetary amount among one or more allocation folders backed by one or more deposit accounts of the plurality of monetary accounts per directions received from the account holder.

20. A machine readable medium comprising a plurality of instructions that in response to being executed, result in an account management system
identifying a cardholder of a received card transaction that has an associated monetary amount, and
distributing the monetary amount of the card transaction among a plurality of monetary accounts of the cardholder in response to receiving, prior to expiration of a float time period assigned to the card transaction, directions from the cardholder to distribute the monetary amount of the card transaction among the plurality of monetary accounts.

21. The machine readable medium of claim 20, wherein the plurality of instructions further result in the account management system distributing the monetary amount to a single identified monetary account of the plurality of monetary accounts in response to receiving directions to allocate the monetary amount of the card transaction to the single identified monetary account.

22. The machine readable medium of claim 20, wherein the plurality of instructions further result in the account management system distributing the monetary amount of the card transaction among two or more monetary accounts of the plurality of monetary accounts in response to receiving directions to distribute the monetary amount of the card transaction among the two or more monetary accounts.

23. The machine readable medium of claim 20, wherein the plurality of instructions further result in the account management system allocating the monetary amount of the card transaction to a default account of the plurality of monetary accounts in response to the float time period for the card transaction expiring prior to receiving directions from the cardholder.

24. The machine readable medium of claim 20, wherein the plurality of instructions further result in the account management system extending the float time period associated with card transaction, and charging the cardholder for extending the float time period.

25. The machine readable medium of claim 20, wherein the plurality of instructions further result in the account management system adding the card transaction to an inbox comprising card transactions to distribute among the plurality of monetary accounts, and presenting transactions of the inbox to the cardholder in response to the cardholder accessing the inbox.
